(19) United States
(12) Patent Application Publication
(10) Pub. No.: US 2014/0299207 A1
(43) Pub. Date: Oct. 9, 2014

(54) INJECTION SYSTEM

(71) Applicant: Liebherr Machines Bulle SA, Bulle (CH)

(72) Inventors: Richard Pirkl, Bulle (CH); Thibault Kämmerlen, Bulle (CH); Thomas De Rigal, Jougne (FR)

(21) Appl. No.: 14/356,714

(22) PCT Filed: Oct. 10, 2012
(86) PCT No.: PCT/EP2012/004244

§ 371 Date: May 7, 2014

(30) Foreign Application Priority Data
Nov. 7, 2011 (CH) 01784/11

(51) Int. Cl. F02M 57/02

(52) U.S. Cl. CPC F02M 57/02
USPC 137/565.11

(57) ABSTRACT

The invention relates to an injection system which includes a line which is connected with a pump. Furthermore, the injection system includes at least two branch lines which are connected with the line such that the fluid flowing in the line is split up onto the at least two branch lines. At least one branch line is connected with at least one injection means.

This invention relates to an injection system according to the generic part of claim 1.

From the prior art, a multitude of injection systems are known, by means of which for example fuel is injected into an engine cylinder. There are known injection systems in which a pump, in particular a high-pressure pump is provided, which delivers the fuel from a reservoir to the injection means, in particular injectors. Via a line, the pump is connected with a plurality of series-connected injection means.

There are also known common-rail injection systems, in which the pump likewise serves for delivering fuel from a reservoir and via a line is connected with an accumulator means, which also is referred to as rail. The individual injection means each are connected with the accumulator means, wherein the accumulator means has the function of storing the fuel at high pressure.

In the known injection systems it is disadvantageous that the pressure loss in the line between the pump and the injection means is high. The pressure loss in the line must be compensated by a higher performance of the pump, in order to provide for an exact operation of the injection system. Furthermore, in particular in the injection system in which no accumulator means is provided for storing the pressure, it is disadvantageous that pressure harmonics with high amplitudes can be produced in the line system. The amplitude of the pressure harmonic depends the pressure fluctuations caused by the pump and the injection means and on the pressure losses obtained in the injection system itself. The pressure harmonics can damage the components, such as e.g. pump, injection means, etc., present in the injection system. In addition, the pressure harmonics can disadvantageously influence the accuracy of the quantity injected by the individual injection means for example into an engine cylinder.

The object of the invention consists in providing an injection system which at least does not have the disadvantages mentioned above.

This object is solved by the subject-matter of claim 1. Advantageous aspects of the invention are subject-matter of the sub-claims.

According to the invention, the injection system includes a pump for delivering a fluid, in particular fuel, and a line which is connected with the pump. The line is connected with at least two branch lines. Furthermore, the injection system includes at least one injection means, via which the fluid can be injected for example into an engine cylinder. At least one branch line is connected with at least one injection means.

By connecting the line with at least two branch lines, it is achieved that the fluid flowing in the line, in particular the volume flow of the fluid, is split up onto the at least two branch lines. By splitting up the fluid stream, the resulting pressure loss in the injection system, in particular in the branch lines, is reduced, since the pressure loss in the line or the branch line depends on the volume flow, among other things. As compared to the prior art, the power output by the pump thereby can be reduced, wherein it is ensured at the same time that the pressure existing at the injection means is high enough, so that an exact injection quantity is output by the injection means.

A further advantage of connecting the line with at least two branch lines consists in that the amplitude of the pressure harmonics can be reduced significantly. The service life of the components present in the injection system thereby is increased, and in contrast to the prior art the accuracy of the quantity injected by the individual injection means can be dosed more precisely and is not influenced disadvantageously.

In the sense of the invention, branching point is understood to be that region of the line in which the line is connected with at least one further line. Branch line is understood to be every fluid line which is arranged downstream of the branching point. Thus, the further line subsequently will be referred to as branch line.

Splitting up the fluid flowing in the line into the at least two branch lines can be controlled by a valve which is connected with a control unit. In particular, the control unit can effect that the fluid flowing in the line is split up in equal parts onto the at least two branch lines. It is of course possible that due to the constructive formation of the at least two branch lines in the connecting region with the line a constant splitting ratio of the fluid stream into the at least two branch lines is formed. At the branching point, the at least two branch lines can be connected with the end of the line facing away from the pump.

In a preferred embodiment, an accumulator means can be provided in at least one branch line. The injection means can be connected with the accumulator means and be formed as solenoid valve injector or as piezoinjector. The accumulator means can be a cylindrical container. Providing the accumulator means offers the advantage that pressure oscillations, which are produced for example by the pulsating pump delivery and/or the injections of the injection means, can be attenuated. By forming the injection means as solenoid valve injector or as piezoinjector it can be made possible that exact injection quantities are injected for example into the engine cylinder.

The at least two branch lines can be connected with each other via a throttle. By providing the throttle, pressure fluctuations in the line and hence in the at least two branch lines can be reduced or compensated, which are produced when the fluid is injected by the injection means for example into the engine cylinder and/or by a delivery of the fluid by the pump. By providing the throttle it finally is achieved that the same pressure exists in the branch lines connected with each other, whereby an exact injection via the injection means becomes possible, since the injection quantity among other things depends on the pressure existing at the injection means.

The at least two branch lines which are provided with an accumulator means can of course also be connected with each other via the throttle. The throttle can be arranged in the respective branch line such that it connects the ends of the at least two branch lines remote from the line or the branching point with each other.

In a preferred embodiment, at least one first and one second branch line can be connected with each other and with the line in the branching point. The distance between the branching point and at least one injection means, which is connected with the first branch line, can be equal to a distance between the branching point and at least one other injection means, which is connected with the second branch line. This can be achieved by a corresponding formation of the line and/or the at least two branch lines, since the position of the injection means is firmly specified for example by the engine cylinder.

Since the pressure loss also depends on the length of the flow path, with otherwise identical conditions in the first and second branch line, the pressure loss of the fluid flow to the injection means which are connected with the first or second branch line is the same in the aforementioned embodiment. Thus, at the two injection means of the first and second branch line the same pressure exists, whereby it is ensured that by the two injection means the same injection quantity can be injected for example into an engine cylinder. It is of course possible that the distances of the injection means connected with the first branch line to the branching point differ from the distances of the injection means connected with the second branch line to the branching point. This can be necessary for example due to the available installation space for the branch lines.

The individual branch lines themselves in turn can be connected with at least two partial lines. It thereby is achieved that the fluid stream, in particular the volume flow, is split up further in the respective branch line. As a result of the fluid stream being split up by the branch line onto the partial lines, the fluid stream in the branch line is reduced, whereby the pressure loss becomes smaller. The partial line is connected with at least one injection means. In the sense of the invention, partial line is understood to be that fluid line which conducts the fluid downstream of a connecting point between the branch line and another line.

The at least two branch lines can have a different flow cross-section. By a corresponding choice of the flow cross-section of the branch line or a region of a branch line, the pressure loss can be influenced. The line and the two branch lines can be formed as tube with a circular cross-section. The line and the branch lines can of course have a cross-section other than circular.

Furthermore, the pressure loss can be reduced in that the line and/or the branch line and/or the partial line are formed of steel. Lines and/or branch lines and/or partial lines formed of steel have a smooth surface structure and hence a low equivalent sand roughness, so that the pressure loss of the fluid is low when there is a flow through these lines.

A further possibility of reducing the pressure loss consists in that an inlet of the branch line in the branching point and/or an inlet into the injection means is rounded in the transition region between injection means and branch line and/or accumulator means.

The injection system can be formed such that it is adapted to a specified ignition sequence of engine cylinders. In particular, the branch lines can be formed such that the injection means each associated to the engine cylinder of engine cylinders to be ignited one after the other is connected with different branch lines. It can thereby be achieved that the pressure fluctuations caused by an injection cannot negatively influence the injection of the fluid into another engine cylinder. In particular, the pressure fluctuations caused during the injection cannot impair an injection quantity of the succeeding injection means, since the same is connected with another branch line.

It is of course also conceivable that the connection of the injection means with the respective branch lines does not depend on the ignition sequence of the engine cylinders. It must merely be ensured that, for example by means of a throttle and/or via an accumulator means, the pressure is kept sufficiently constant, in order to ensure a reliable and controlled injection.

The injection system can be operated in a pressure range between 200-2,500 bar. The injection system, in particular fuel injection system, can be used in a motor vehicle. The use of the injection system is of course also possible in another object, in particular in all objects in which a diesel combustion engine is employed.

In the drawing, the subject-matter of the invention is represented schematically and is described below with reference to the Figures, wherein identical elements or elements with the same effect mostly are provided with the same reference numerals.

In the drawing:

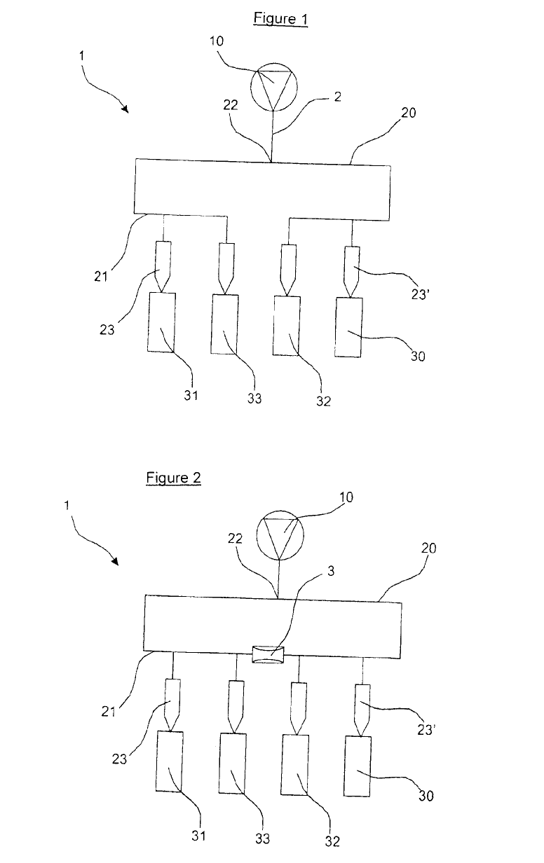

FIG. 1 shows a schematic representation of the injection system of the invention according to a first embodiment,

FIG. 2 shows a schematic representation of the injection system of the invention according to a second embodiment,

The injection system 1 shown in FIG. 1 includes a pump 10 for delivering a fluid, in particular fuel, and a line 2 which is connected with the pump 10. At its end remote from the pump 10, the line 2 is connected with a first and a second branch line 20, 21 in a branching point 22. The first and second branch lines 20, 21 each are connected with two injection means 23, 23′. The individual injection means 23, 23′ are arranged in the first and second branch line 20, 21 one after the other as seen in flow direction. Via the injection means 23, 23′, the fluid delivered by the pump is injected into the engine cylinders 30-33.

The injection means 23, 23′ are connected with the corresponding branch lines 20, 21 corresponding to the ignition sequence of the engine cylinders 30-33, wherein the ignition sequence of the engine cylinders is firmly specified. Thus, the ignition of the engine cylinders is effected corresponding to the ascending numbering of the engine cylinders. Here, this means that first an ignition of the engine cylinder 30 and subsequently of the engine cylinder 31 followed by engine cylinder 32 is effected and the engine cylinder 33 is ignited last. As shown in FIG. 1, the injection means 23 associated to the engine cylinder 30 is connected with the first branch line 20. The injection means 23′, which is associated to the engine cylinder 31 to be ignited subsequently, is connected with the second branch line 21.

The pump 10 or the line 2 is arranged in the injection system 1 such that a distance between the branching point 22 and another injection means 23′, which is connected with the first branch line, is equal to a distance between the branching point 22 and an injection means 23, which is connected with the second branch line. As a result, the pressure loss between the branch line and the respective injection means 23, 23′ is equal in both branch lines 20, 21.

The injection system 1 shown in FIG. 2 differs from the injection means shown in FIG. 1 in that the first and second branch line 20, 21 are connected with each other via a throttle 3. The throttle 3 connects the ends of the two branch lines 20, 21 remote from the branching point 22 with each other.

In the following, the injection operation by means of the injection system 1 will be described. Although the description of the injection operation is effected by means of the reference numerals, the injection operation is not limited to the injection system 1 shown in the Figures.

The fluid stream delivered by the pump 10 in line 2 is split up into the branch lines 20, 21. Via the injection means 23, 23′ connected with the respective branch line 20, 21 an injection of the fluid is effected into the engine cylinders 30-33. The injection of the fluid is effected corresponding to the ignition sequence of the engine cylinders, wherein the two injection means 23, 23′, which subsequently are associated to the engine cylinders 30, 31 to be ignited, are not connected with the same branch line 23, 23′.

### LIST OF REFERENCE NUMERALS

1 injection system

2 line

3 throttle

10 pump

20 first branch line

21 second branch line

22 branching point

23, 23′ injection means

30-33 engine cylinders

1. An injection system (1) with at least one injection means (23), a pump for delivering a fluid, in particular fuel, and a line (2) which is connected with the pump (10), wherein
the line (2) is connected with at least two branch lines (20, 21) such that the fluid flowing in the line (2) is split up onto the at least two branch lines (20, 21), and
at least one branch line (20, 21) is connected with at least one injection means (23).

2. The injection system (1) according to claim 1, wherein in at least one branch line (20, 21) an accumulator means is provided and the injection means (23) is connected with the accumulator means.

3. The injection system (1) according to claim 1, wherein the at least two branch lines (20, 21) are connected with each other via a throttle (3).

4. The injection system (1) according to claim 3, wherein the throttle (3) is arranged at an end of the branch line (20, 21) remote from the line (2).

5. The injection system (1) according to claim 1, wherein the at least two branch lines (20, 21) have a different flow cross-section.

6. The injection system (1) according to claim 1, wherein
a first and a second branch line (20, 21) are connected with each other and with the line (2) in a branching point (22), and
the distance between the branching point (22) and an injection means (23), which is connected with the first branch line, is equal to the distance between the branching point (22) and another injection means (23′), which is connected with the second branch line.

7. The injection system (1) according to claim 1, wherein
the respective branch line (20, 21) is connected with at least two partial lines, and
at least one injection means (23) is connected with the respective partial line.

8. The injection system (1) according to claim 1, wherein
the injection system (1) each includes an engine cylinder associated to the injection means (23), and
the injection means (23) of engine cylinders to be ignited one after the other are connected with different branch lines (20, 21).

9. The injection system (1) according to claim 1, wherein the line (2) and/or the branch lines (20, 21) are formed of steel.

10. A motor vehicle with an injection system (1), in particular a fuel injection system, according to claim 1.

11. The injection system (1) according to claim 2, wherein the at least two branch lines (20, 21) are connected with each other via a throttle (3).

12. The injection system (1) according to claim 11, wherein the throttle (3) is arranged at an end of the branch line (20, 21) remote from the line (2).

13. The injection system (1) according to claim 12, wherein the at east two branch lines (20, 21) have a different flow cross-section.

14. The injection system (1) according to claim 11, wherein the at least two branch lines (20, 21) have a different flow cross-section.

15. The injection system (1) according to claim 4, wherein the at east two branch lines (20, 21) have a different flow cross-section.

16. The injection system (1) according to claim 3, wherein the at least two branch lines (20, 21) have a different flow cross-section.

17. The injection system (1) according to claim 2, wherein the at least two branch lines (20, 21) have a different flow cross-section.

18. The injection system (1) according to claim 14, wherein
a first and a second branch line (20, 21) are connected with each other and with the line (2) in a branching point (22), and
the distance between the branching point (22) and an injection means (23), which is connected with the first branch line, is equal to the distance between the branching point (22) and another injection means (23′), which is connected with the second branch line.

19. The injection system (1) according to claim 13, wherein
a first and a second branch line (20, 21) are connected with each other and with the line (2) in a branching point (22), and
the distance between the branching point (22) and an injection means (23), which is connected with the first branch line, is equal to the distance between the branching point (22) and another injection means (23′), which is connected with the second branch line.

20. The injection system (1) according to claim 12, wherein
a first and a second branch line (20, 21) are connected with each other and with the line (2) in a branching point (22), and
the distance between the branching point (22) and an injection means (23), which is connected with the first branch line, is equal to the distance between the branching point (22) and another injection means (23′), which is connected with the second branch line.
